(19) United States
(12) Patent Application Publication
(10) Pub. No.: US 2019/0187317 A1
(43) Pub. Date: Jun. 20, 2019

(54) OFFSHORE RESERVOIR MONITORING SYSTEM AND METHOD FOR ITS OPERATION

(71) Applicant: SOUNDSABRE LIMITED, Dorchester Dorset (GB)

(72) Inventors: Giles Francis Tanfield WATTS, Dorchester Dorset (GB); Ian Gordon JACK, Waresley Cambridgeshire (GB); Mark VOLANTHEN, Winchester Hampshire (GB)

(21) Appl. No.: 16/099,732

(22) PCT Filed: May 30, 2017
(86) PCT No.: PCT/GB2017/051542

§ 371 Date: Nov. 8, 2018

(30) Foreign Application Priority Data
Jul. 27, 2016 (NO) 20161234

(51) Int. Cl. G01V 1/52; G01V 1/22

(52) U.S. Cl. CPC G01V 1/52; G01V 1/226; G01V 2210/1427; G01V 2210/3246; G01V 2210/1234

(57) ABSTRACT

An offshore reservoir monitoring system (100) comprises a vertical array (110) with multiple seismic receivers (120) less than 10 m apart. During operation, the vertical array is deployed in a shallow borehole (111) in a seabed (10) away from noise at a seafloor (11). The dense spacing of receivers (120) ensures an adequate number of sensors (120) in the shallow borehole (111) and a spatial sampling rate appropriate for suppressing coherent noise in the shallow layers under the seafloor (11). Vertical arrays (110) can be added to the system (100) at any time.

### BACKGROUND

### Field of the Invention

The present invention relates to active and/or passive seismic monitoring of a subsurface geologic formation under a body of water. Specifically, the invention concerns an offshore reservoir monitoring system and a method for its operation.

### Prior and Related Art

In the following, an offshore reservoir is any multi-layered structure of sediments and rock under a body of water. The term “surface” will refer to the sea surface above the body of water, and the term “seafloor” means the interface between the body of water and a “seabed”. As used herein, the seabed is the upper layers of the Earth's crust, and may comprise sediments or solid rock.

A reservoir may produce hydrocarbons through a production well and/or be used as a storage facility, e.g. for CO₂. Monitoring a field has several aims, e.g. identifying a water front approaching a production well, characterising cracks developing during injection or monitoring natural seismicity.

Active seismic monitoring essentially involves generating a powerful acoustic signal and analysing echoes reflected and refracted from the different interfaces in the reservoir. Passive monitoring includes listening for and determining the focal point mechanism, location and size of a microseismic event, e.g. to monitor the development of a fracture during injection and the detection of natural ambient noise and events which occur due to natural physical processes, for example release of stress.

The recorded signals include pressure waves (P-waves) and shear waves (S-waves). These are called body waves, and carry information about the underground structure. P-waves are detected by hydrophones and geophones. S-waves do not travel through fluids, and are detected by geophones in mechanical contact with the seabed.

The body wave signals are typically weak and noise reduction is important in all seismic data acquisition. Some noise may be removed by burying the receivers, for example in a trench close to the seafloor or along a vertical cable in a borehole. Additionally, noise may be removed by signal processing anywhere in the processing path from recording to a model of the reservoir. For example, stacking several traces amplify a coherent signal by addition, while incoherent signals cancel. Signals may be phase shifted to compensate for distances between receivers before stacking. Thus, simple stacking or beamforming and stacking remove random noise. Some harmonic noise, e.g. signals generated by a pump or drill string, may be removed by bandpass filtering anywhere in the processing path.

The P-waves and S-waves are called body waves. Surface or interface waves is another broad category of seismic waves that propagate along boundaries between different media. We will use the term “interface waves” throughout to avoid confusion with surface waves on an ocean, which are restored by gravity rather than elastic properties of a solid. A first example of interface waves is Rayleigh-waves that describe the ground roll after an earthquake and similar waves generated by a thumper truck in onshore seismic. These may be considered interface waves between the ground and air. Similarly, Stoneley-waves occur in the interface between two solids and Scholte waves describe interface waves between water and a seabed. In some instances, noise from Rayleigh and Scholte waves may be suppressed by burying sensors in the ground as the intensity of interface waves decreases exponentially with the distance from the interface. However, it may not be possible or desirable to bury the sensors away from interface waves. In these cases, the interface waves can only be removed by sampling and wave reconstruction currently unavailable from most recording systems. Thus, Scholte waves and related phenomena contaminate seismic data acquired by most seabed sensors. Scholte waves are also used to image velocity variations in the first 1000 m below the seafloor. There will be advantage both in suppressing Scholte waves for P-wave and S-wave imaging and in enhancing them for Scholte wave imaging.

The reservoir monitoring market uses three main technologies—repeat towed streamer surveys (“4D Seismic”), repeat ocean bottom surveys (“4D OBS”) and permanent reservoir monitoring (“PRM”) using networks of trenched cables containing seabed receivers.

Towed streamer 4D is the most common method and usually optimises infill drilling programs. However, towed streamer 4D suffers from low repeatability and long times between reshoots, typically 2-10 years, which limits its applicability to fields with a strong time-lapse signature and slow reservoir changes. In addition, towed streamers do not record S-waves as shear waves do not propagate through water.

In practice, the seismic world is gradually moving away from towed streamer acquisition for producing fields as seabed-based seismic produces superior images due to better sampling with full azimuths, higher trace densities and 4C recordings of the wavefield using X, Y, Z and pressure components.

In 4D OBS, seabed sensors are deployed for the duration of a survey while a PRM system is installed for the lifetime of a field and so requires infrastructure for power supply and communication. Both kinds of systems may use a source vessel firing shots at predetermined points on the sea surface. In some instances, e.g. to reduce exploration costs, the distance between shots is too coarse for proper sampling of the body wavefields.

This may be alleviated by sampling the first and optionally second derivatives of pressure and particle displacements and using a suitable interpolation as proposed in Amundsen et al.: “Multicomponent ocean bottom and vertical cable seismic acquisition for wavefield reconstruction”, Geophysics vol. 81 no. 3, November 2010. This article also suggests a seabed cube of sensors, which most likely would be too expensive and impractical for commercial use.

Some PRM systems deploy seismic sensors in cables that are buried 0.5-1.0 m below the seafloor. Each sensor package typically contains three orthogonal geophones with an additional hydrophone. Such sensors are well known in the art, and will be termed four component (4C) sensors in the following. PRM systems with 4C sensors are most sensitive to time-lapse seismic signals due to their very high repeatability and so generate the best images of 4D effects in the subsurface.

The use of PRM-systems has grown gradually over the last decade but they are relatively expensive to install and usually require more than five years to plan, fund and execute. These systems need to be connected to fixed infrastructure which adds to the cost and makes them inflexible and non-scalable as a small array can cost almost as much as a large one. In addition, the single sensor locations are still affected by noise trapped in the water column and from interface waves at the seafloor. They also have problems with coupling between the sensors. Finally, seafloor arrays often have an inline sensor distance of 50 m and a crossline distance of 350 m or more. Such distances are too large to provide the sampling required for effective removal of interface waves at the seafloor.

Passive seismic monitoring detects seismic and microseismic events generated by natural and man-made processes. Passive monitoring is often used to maximise well productivity in well stimulation and to monitor safety concerns especially to do with water/gas injection under pressure, the integrity of wells and the release of hydrocarbons underground.

Passive monitoring is common onshore to monitor fracking in shale hydrocarbon fields. Land microseismic monitoring systems tend to use wells which are 100-250 m deep with 1-5 sensor levels. Sometimes 4C sensors are deployed and sometimes only one single vertical geophone is used at each level to reduce the cost. These systems are optimised for land systems where it is critical to get into the water saturated zone and below the complex near-surface and to get the sensors as deep as possible so that they are closer to the source of the microseismic signals. On land, multiple levels are less important for picking up microseismic events and the noise characteristics are different.

As indicated, the seafloor is a noisy place with the Scholte waves described previously, mode conversions from shear waves and diffractions from near surface anomalies. In addition, water currents generate noise by causing nodes and cables on the seafloor to vibrate. Seafloor sensors also detect noise trapped in the water, e.g. from nearby installations and activities. Finally, the sensitivity of seafloor nodes for passive monitoring is low due to poor mechanical coupling to the seabed, high levels of noise, and often strong absorption in the very shallow layers.

At present, there are few or no dedicated products available for passive monitoring offshore. Options include PRM systems, stand-alone monitoring nodes placed on the seabed and well-based monitoring systems. PRM systems are designed for active surveys and since they are located very near the surface they are still affected by noise generated by the irregularity of the seabed, by noise from other sources which propagates along the seabed and diminished signals caused by the long distance from the source. Stand-alone monitoring nodes placed on the surface have been shown to be even more susceptible to surface noise and so ineffective for all but the strongest microseismic signals. Well based monitoring is the most effective for localised microseismic monitoring but is also by far the most expensive.

Deployment in production and injection wells is rarely approved due to the extra risk of completion failure and deployment in a dedicated monitoring well is still too expensive for many applications. Current developments include single fibre seismic sensors called Distributed Acoustic Sensors (DAS). DAS-sensors rely on Rayleigh backscattering, and are currently too insensitive for effective monitoring of the weak microseismic signals. This may change in the future.

The objective of the present invention is to solve or alleviate at least one of the problems described above while retaining the benefits of prior art.

### SUMMARY OF THE INVENTION

This is achieved by an offshore reservoir monitoring system according to claim 1 and a method for its operation according to claim 7. Additional features and benefits appear from the dependent claims.

In a first aspect, the invention concerns an offshore reservoir monitoring system. The system has a vertical array with multiple seismic receivers suitable for installation in a seabed and a recording node for deployment on the seabed and for recording data from the multiple seismic receivers. The spacing between adjacent seismic receivers is less than 10 m.

The spacing between adjacent sources may be as small as 1 m. The small spacing between sensors provides a sufficient sampling frequency to characterise and remove coherent noise, e.g. from Scholte waves, echoes reflected from the surface and other unwanted signals that are often referred to as noise. Temporal phase shifts between signals from adjacent receivers provide beamforming capabilities causing the vertical array to work like a directional antenna. This helps in determining the hypocentre and focal point mechanism of a microseismic event and for pinpointing the source of a reflected or refracted body wave. Simple stacking or beamforming and stacking remove random noise, i.e. noise that cancel by addition.

Preferably, at least one, and usually most, of the seismic receivers comprise three orthogonal geophones. These detect particle velocity or acceleration in three spatial directions and are suitable for detecting P-waves, S-waves as well as other modes such as interface waves that can be characterised in the seismic records. Advantageously, the vertical receiver array generates vector phase shifts between the receiver levels to characterise and remove the noise and differential vector phase shifts to provide estimates of the vertical and horizontal gradients of the signal wavefield.

Some of the geophones may be replaced with special low frequency geophones designed to detect the much lower frequencies, for example with periods of several minutes. This will make the vertical array attractive for detecting natural earthquakes and measuring their total moment or magnitude.

In addition or alternatively, the seismic receivers may also include one or more hydrophones detecting the P-wave pressure signal, e.g. one hydrophone per receiver. Where the pressure signals travel through the sediment to the hydrophones without too much attenuation, these are recorded by the hydrophones, which can improve the overall estimate of the P-wave signal strength.

In currently preferred embodiments, several vertical arrays are deployed in the seabed. Thereby, each sensor is removed from the noisy interface at the seabed, and the mechanical coupling to the geological structure is superior to that of present PRM or seabed microseismic monitoring systems. The vertical array and the recording node preferably form an independent unit that is installed in and on the seabed. However, embodiments with several vertical arrays connected to one recording node are anticipated. Vertical arrays may also be connected to the platform or other facilities infrastructure if real-time recordings are justified by the additional costs of a permanent communication link.

The deployment of the vertical arrays is easily scalable so they can be can be deployed singly, in small groups or across a whole field. Thereby, a small number of vertical arrays can be deployed as a pilot so that the business benefits can be demonstrated without the cost of a large installation.

In embodiments comprising several vertical arrays, the distance between the vertical arrays is much larger than the spacing between adjacent seismic receivers levels. For example, the horizontal distance between receivers may be 250-500 m while the spacing between receiver levels is less than 10 m as specified. This saves installation and operational costs without sacrificing sensitivity, and is due to the high spatial sampling of the vertical arrays and the ability to calculate the gradient of the wavefield.

In some embodiments, the vertical array is a fully sealed system with fibre-optic seismic sensors. That is, the geophones and/or hydrophones are fibre-optic devices based on, for example, Rayleigh back scattering or Michelson interferometry. Such devices can be built to be more robust than electrical systems, and are just as sensitive to small seismic signals.

In a second aspect, the invention provides a method for operating a system as described above. The method comprises the steps of: installing the vertical array; recording data from the seismic receivers on the recording node; performing an active survey at first predetermined intervals; monitoring microseismic events between active surveys; and harvesting data from the recording node at second predetermined intervals using an underwater vessel.

The steps may be performed in any order, e.g. such that a vertical array may be installed after a pilot phase as explained above. The receivers should have a sufficient dynamic range for recording data during passive monitoring of microseismic events and during the active surveys.

Preferably, installing the vertical array involves deploying the vertical array by a technique selected from a group consisting of flush drilling, percussion drilling and drilling with a drill bit.

In all circumstances, rotary flush drilling can be used to drill the hole for the sensor array. The sensor array is then installed in the hole, and fixed in place using cement, grout or by forcing the collapse of the formation around the hole. In some instances, e.g. for a shorted sensor array and lower sediment shear strengths, percussion or “push” drilling is a fast and cost-effective way install the sensor array in the ground. In this case, a specially designed sensor array is required. Deployment rates an order of magnitude better may be achieved.

Independent of drilling technique, the installed vertical arrays preferably extend less than 100 m from a seafloor defined as the interface between the seabed and a body of water above. In some cases, the array can extend less than 30 m from the seafloor without loss of benefit.

Recording data may involve signal processing at the recording node. The main advantage is to save storage space, especially during microseismic monitoring.

Specifically, recording data may involve deriving one or more vector gradients of one or more wavefields for signals coming from a variety of vertical and non-vertical angles. This can be done using differential vector phase shifts as mentioned above, and allows double spatial frequencies to be estimated. In this way, the source or receiver spacing can be twice what they are for a conventional seafloor array without loss of image quality. Thus, the monitoring survey can be performed with less equipment and in a shorter time, both of which reduce the cost of a survey. Alternatively, the image quality may improve significantly without a corresponding raise in survey costs.

Recording data may involves sampling data for suppressing coherent noise. As noted, the dense vertical array(s) sample(s) the upper part of the seabed with sufficient spatial density to identify waves or wavefields, e.g. to suppress Scholte waves in P-wave and S-wave imaging. Other potential uses include ghost removal of waves reflected from the surface during an active survey, i.e. separating up-going and down-going wavefields that are identifiable due to an improved spatial sampling rate. As noted in the introduction, the sampled Scholte waves may also be used for Scholte wave imaging. Either way, it is understood that sampling in space and time is required for transformation into the frequency-wavenumber (f-k) domain—sampling in space or time alone is insufficient.

Harvesting data could involve retrieving the recording node from the seabed, e.g. about every 1-2 years for transferring data to a central storage and maintenance such as recharging or replacing batteries, recalibrating atomic clocks etc. In addition, the data could be harvested, periodically, e.g. every few weeks or months by using optical pulses over short distances to an underwater vessel traveling between the seafloor and a mother vessel on the surface. Of course, clocks could be synchronised and data transferred in the opposite direction using this optical link.

### BRIEF DESCRIPTION OF THE DRAWINGS

The invention will be explained with reference to exemplary embodiments and the accompanying drawings, in which:

FIG. 1 illustrates a vertical array according to the invention;

FIGS. 1a-c illustrate vector differences;

FIG. 2 illustrate a system with several vertical arrays;

FIG. 3 illustrates a field wide three-dimensional receiver array;

FIG. 4 illustrates a method according to the invention

### DETAILED DESCRIPTION OF A PREFERRED EMBODIMENT

The drawings are schematic and not to scale. For ease of understanding, numerous details known to the skilled person are omitted from the drawings and following description.

The problem at hand may loosely be described as measuring a property u(x, t)=(u(t), v(t), w(t)) at discrete points (X, Y, Z, t) in space and time. A formal discussion of known representations of the seismic equations is beyond the scope of this disclosure. However, we note that the problem may be described as determining a boundary condition or final state, hereinafter a “wavefield” for short, sampled at discrete points (X, Y, Z, t) in space-time. Hence, the Nyquist-Shannon sampling theorem is central to ensure proper reconstruction of the full wavefield in spatial and temporal directions, and appears in some examples below.

The focal point mechanism describes the nature of a microseismic event, e.g. a dip slip, strike slip, dilation or a combination, and is typically derived from observation of “first motions”, e.g. whether the first arriving P wave breaks up or down. Alternatively, the moment tensor and slip vector at the focal point may be computed using digitally sampled wavefields and/or their transforms in the frequency-wavenumber (f-k) domain. Either way, the observations regard P and S-waves arriving at different spatial locations as known in the art.

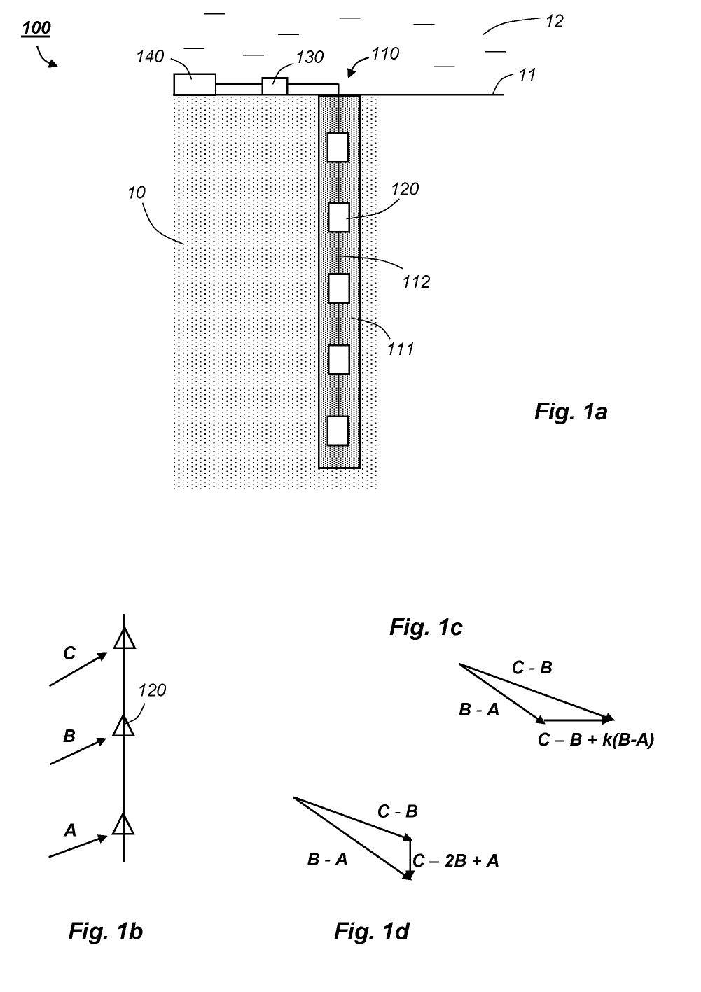

FIG. 1a illustrates a system 100 according to the invention installed in and on a seabed 10 under a body of water 12. The system 100 comprises a vertical array 110 with a cable 112 connected to multiple seismic receivers 120, a connector 130 and a seabed recording node 140 on the seafloor 11, i.e. the interface between the seabed 10 and the body of water 12.

Specifically, the vertical array 110 is installed in a shallow borehole, e.g. extending 10 to 100 m downward from the seafloor 11. The seabed 10 may comprise sediments such as sand and clay above a layer of solid rock. In all circumstances, rotary flush drilling can be used to drill the hole for the sensor array. The sensor array is then installed in the hole and fixed in place using cement, grout or by forcing the collapse of the formation around the hole. In some instances, e.g. for a shorted sensor array 110 and lower sediment shear strengths, percussion or “push” drilling is a fast and cost-effective way to install the sensor array 110 in the seabed 10. In this case a specially designed sensor array is required. Deployment rates an order of magnitude better may be achieved. A small number of vertical arrays 110 may be installed around a well or platform for fraction of the cost of a traditional PRM system with associated infrastructure.

The design of the seismic receivers 120 depends on intended use. For example, it may be desirable to include the system 100 in a global or regional receiver array for earthquakes. In this case, most receivers 120 might comprise standard geophones configured to detect frequencies in the high frequency range 0.5-1000 Hz, i.e. signals with periods two seconds or less. The remaining receivers 120 might contain geophones designed to detect low frequencies associated with earthquakes, e.g. signals with periods 20 seconds or more. Moreover, the incoming signals may be band-pass filtered such that the signal is zero outside a specified range. Signals having a Fourier transform satisfy the Nyquist-Shannon criterion and may be completely restored if sampled above the Nyquist frequency. For example, signals in the range 0.5-1000 Hz may be restored completely in the time domain if sampled at a frequency above 2×(1000−0.5) Hz≈2 kHz. Similarly, the spatial sampling rate required for wavefield reconstruction is less for long wave signals, so sparsely distributed low frequency geophones may still provide adequate sampling of the wavefield.

The sensors detecting particle motion may include inexpensive MEMS accelero-meters integrating over time to provide particle velocities in three spatial dimensions. Other geophones may rely on different known principles. Further, hydrophones are optional, but may provide valuable additional information on P-waves. Most hydrophones may be inexpensive electrostatic devices, and the remaining fraction, e.g. 10%, may be high-grade.

The design of receivers 120 also depends on the technique selected for deployment. For example, fibre optic sensors withstand the shocks involved in percussion drilling while fragile instruments with movable parts do not. As noted in the introduction, DAS sensors use the principle of Rayleigh backscattering, and are at present not sensitive enough for use in the system 100, although this could change in the future. However, fibre-optic sensors based on Michelson interferometry to measure phase changes are sensitive enough. The vertical array 110 could for example be a fully sealed system with distributed sensors separated by Fibre-Bragg gratings or semi-silvered surfaces. This embodiment would have no moving parts and be suitable for percussion installation. A potential disadvantage would be the increased power required to drive laser diodes for extracting data from these sensors.

From the previous paragraphs, it should be clear that the actual design of the receiver array 110 and choice of sensors in the receivers 120 must be left to the skilled person.

Grout, cement or concrete 111 in the borehole fixes the position of the array 110 and ensures proper acoustic contact with the seabed 10. The cable 112 connects the receivers 120 to the recording node 140 via the connector 130. The vertical separation or spacing of the receivers 120 is typically about 1 to 5 m, although spacing up to 10 m is possible. The short spacing ensures accurate spatial sampling of the wavefield. In comparison, the sensor spacing in a production well is typically tens of metres. Crossline spacing of hundreds of metres between seafloor nodes are common.

The vertical array 110 acts as an antenna to amplify the signal and directionally tune into signals from a particular part of the deeper subsurface. Specifically, the temporal phase shifts between adjacent receivers indicate a vertical angle, and the sum or average of the signals amplify the desired signals and suppress random noise thereby improving the SNR.

In contrast to land systems using one or two levels, the system 100 will be sampling the seismic events over much smaller intervals allowing the signal and noise wavefields to be characterised. In addition to making the sensor array much cheaper to manufacture, it will also have a major impact on the installation.

In FIG. 1a, each vertical array 110 is connected to one recording node 140 through a connection 130. The connection 130 allows disconnecting the node 140, e.g. for uploading data and maintenance at a mother vessel on the surface and/or replacing the node 140 with a freshly synchronised and fully charged recording node 140. The node 140 can last on the seabed for at least 1 year and is also able to transmit the data periodically to a receiving probe using an optical link enabling the data to be downloaded=from the node whenever desired.

In some embodiments, each recording node 140 may be connected to several vertical arrays 110 or other seabed sensors. Moreover, the signal processing may be divided between the receivers 120 and the recording node 140 in any suitable manner. For example, a typical receiver 120 convert an analogue sensor signal to a digital output, but receivers providing an analogue signal for an A/D-converter in the recording node 140 are not excluded. Similarly, processing to reduce storage requirements are typically performed in the recording node, but does not exclude signal processing in the receivers 120. For example, an accelerometer in the receiver 120 may present a time integrated and sampled signal that can be stored in the recording node 140 without further processing or after additional processing by the recording node 140. Either way, the signal processing is performed at the recording node 140 as opposed to in a central computer facility. Examples of other signal processing that may be performed at the recording node 140 include stacking, identifying a microseismic event in a continuous flow of data and low-pass filtering/anti-aliasing.

FIG. 1b-1d illustrate use of vector differences to estimate horizontal and vertical gradients. For convenience, bold face denotes vector variables throughout this disclosure. Specifically, FIG. 1b shows vectors A, B and C received at three different receivers 120. The vectors form slightly different angles with the vertical, and typically represent vector phases received at three different receivers 120, each receiver 120 comprising three orthogonal geophones. This representation may characterise any wavefield of interest. Alternatively, the vectors A, B and C may represent incoming rays, e.g. obtained by temporal phase shifts. The latter representation may be useful in the “high frequency” range, i.e. frequencies above 0.5 Hz as defined above.

Thus, in FIGS. 1c and 1d, the vector differential B−A between the first two vertical receivers may represent some vector response representing a property parallel to an incoming wave front. Similarly, the differential C−B between the next receiver pair gives the vector response to the next incoming wave front. Linear combinations of the differentials can be used to derive the vertical wavefield gradient as C−2B+A and the horizontal wavefield gradient as C−B+k(B−A). If using a single sensor string proves too difficult or inaccurate to calculate the gradient of the wavefield, sensors from different vertical arrays that are placed near each other may be used.

In general, the vertical differential is easier to calculate than the horizontal but with an array of 6 or 7 three-component receivers, the statistics should be strong enough to obtain an accurate estimate for the scalar value k. The distance between the receivers would have to be precise but could be much less than a (seismic) wavelength apart. The orientation of the array would also have to be tightly controlled. In the more general case, it is assumed that the acoustic impedance of the sediments around the receivers changes as well. Essentially this means that a model of the near surface velocity must be built so that these corrections can be made. This information should be provided by direct arrival times or by using the myriad of seismic traces to model the near surface acoustic contrasts. However it does require sub-millisecond sampling.

In a different approach, consider a smooth function ϕ(x) and the Taylor expansions of ϕ(x±Δx):

$$\begin{matrix}Φ ( x + Δ x ) = Φ ( x ) + \frac{\partial Φ}{\partial x} Δ x + \frac{1}{2} \frac{{\partial }^{2} Φ}{\partial {x}^{2}} {( Δ x )}^{2} + \frac{1}{6} \frac{{\partial }^{3} Φ}{\partial {x}^{3}} {( Δ x )}^{3} + O ( {( Δ x )}^{4} ) . & ( 1 ) \\ Φ ( x - Δ x ) = Φ ( x ) - \frac{\partial Φ}{\partial x} Δ x + \frac{1}{2} \frac{{\partial }^{2} Φ}{\partial {x}^{2}} {( Δ x )}^{2} - \frac{1}{6} \frac{{\partial }^{3} Φ}{\partial {x}^{3}} {( Δ x )}^{3} + O ( {( Δ x )}^{4} ) & ( 2 )\end{matrix}$$

where O((Δx)⁴) means terms of order (Δx)⁴ and higher. The requirement of a smooth function is for example satisfied by a (sum of) plane wave(s) and is not limiting in most applications. Incidentally, a plane wave has a Fourier transform and may be set to zero outside a limited frequency range, e.g. 0.5-1 kHz, as required by the Nyquist-Shannon sampling criterion.

Subtracting (2) from (1) and solving for

$$\frac{\partial Φ}{\partial x}$$

yields:

$$\frac{\partial Φ}{\partial x} = \frac{1}{2 Δ x} [ Φ ( x + Δ x ) - Φ ( x - Δ x ) ] + \frac{1}{3} \frac{{\partial }^{3} Φ}{\partial {x}^{3}} {( Δ x )}^{2} + O ( {( Δ x )}^{4} ) \qquad ( 3 )$$

The leading term after the square brackets is proportional to (Δx)², and defines a maximum error in the approximation

$$\frac{\partial Φ}{\partial x} \approx \frac{1}{2 Δ x} [ Φ ( x + Δ x ) - Φ ( x - Δ x ) ] \qquad ( 4 )$$

Thus, if Δx is “small”, (Δx)² is “negligible” and equation (4) is an acceptable approximation.

Similarly, adding (2) to (1) and solving for

$$\frac{{\partial }^{2} Φ}{\partial {x}^{2}}$$

yields:

$$\frac{{\partial }^{2} Φ}{\partial {x}^{2}} \approx \frac{1}{{( Δ x )}^{2}} [ Φ ( x + Δ x ) - 2 Φ ( x ) + Φ ( x - Δ x ) ] \qquad ( 5 )$$

Equation (5) also has an error term of order (Δx)².

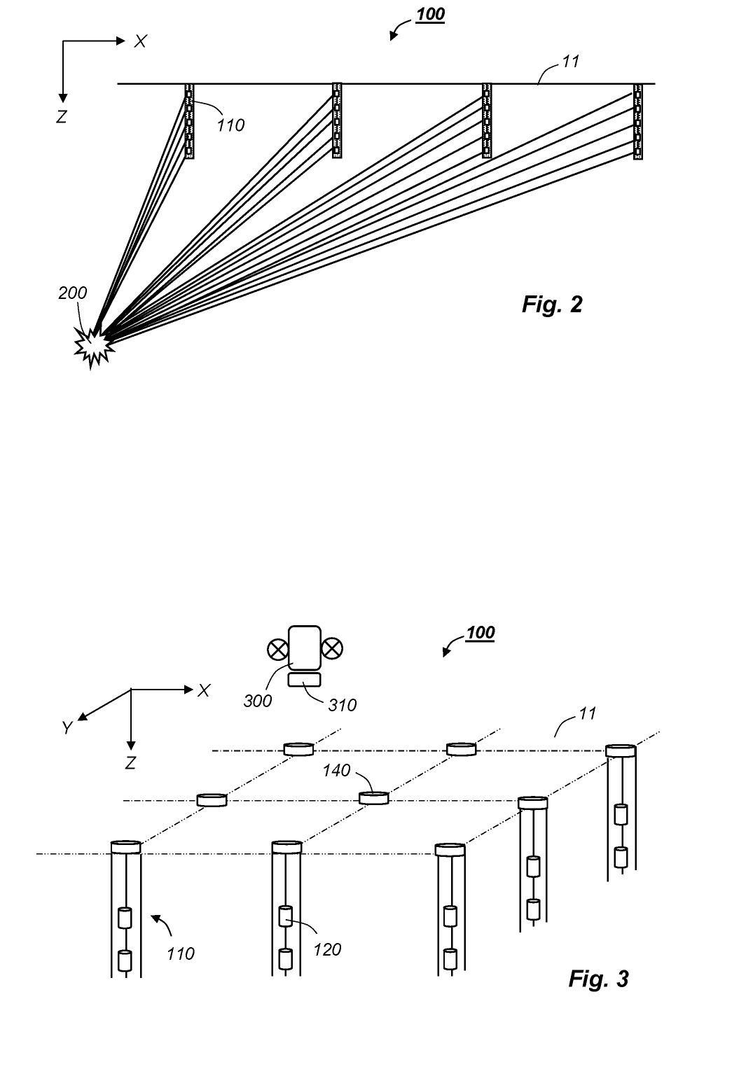

The derivation of equations (4) and (5) illustrate the benefits and limitations of “centred approximation”, which is widely used to estimate functions representing physical properties. Moreover, the variable x is arbitrary and may for example represent a spatial direction or time. Similarly, the function ϕ(x) may represent a particle displacement u(x, t) or its velocity du/dt. Plane waves are already mentioned. Yet another possibility is a convolution of body waves, i.e. a slowly varying function without the “wiggles” of individual P-waves or S-waves, rather than a wave front. Thus, if x is replaced with the spatial variable Z shown in FIGS. 2 and 3 and ΔZ represent the distance between adjacent receivers 120 in a vertical array, it is easily seen that equations (4) and (5) provide accurate estimates for the first and second spatial and temporal derivatives of such convolutes.

The fine sampling prevents aliasing of data arriving at higher angles rather than ultra-high frequency waves travelling along the array.

Another feature of the array 100 is that, when a tight grid of shots is used, each receiver can be recalculated as a virtual source that does not depend on knowledge of the near surface. Although the number of traces generated will be relatively low, this could be used for tomographic imaging in the near surface that may be highly effective for characterising near-surface velocity changes (for example in palaeo-channels) and so help to building a better image at depth.

FIG. 2 illustrates a system 100 with several vertical arrays 110 extending from the seafloor 11. The distance between the vertical arrays 110 in a direction X along the seafloor 11 is substantially longer than the vertical spacing of receivers in the arrays 110.

Under conditions illustrated in a previous example, a “virtual receiver” may be assumed between each physical receiver or vertical array 110. More specifically, assume some function ϕ(x) at a virtual receiver and measured values ϕ(x±Δx) at adjacent receivers. Then, ϕ(x) is the average:

Φ(x)=½[Φ(x+Δx)+Φ(x−Δx)] (6)

Estimates for spatial and temporal first derivatives may be obtained from equation (3). While substituting equation (6) into (5) always yield second derivatives of zero, centred approximation may still be useful e.g. for ray tracing algorithms.

FIG. 3 illustrates a full scale system 100 and a Cartesian coordinate system X, Y, Z in which several vertical arrays 110 are arranged in a row along the X-axis, a plurality of rows are arranged in the Y-direction and each vertical array 110 comprises multiple 4C-sensors 120 arranged in the Z-direction. There are no wired or wireless connections between the recording nodes 140, and the dash-dot lines just illustrate an imaginary grid on the seafloor 11.

Due to the noise reduction and the estimate of higher spatial frequencies, the distance between receiver stations is expected to be about the same as for deep water node surveys (approximately 400-500 m), so approximately 100 vertical arrays and 100 seabed nodes could cover a medium-to-large North Sea field covering 25 square kilometres.

An underwater vessel 300 of any known kind is able to travel through the water column between the nodes 140 and a mother vessel on the surface. Equipment 310 on the underwater vessel 300 is able to receive data from each recording node 140, e.g. over a fast short range optical link. The underwater vessel 300 is also able to disconnect a recording node 140 from an associated connector 130 and retrieve the node 140 to the surface for transferring data to a central computer system, maintenance and recalibration as known in the art.

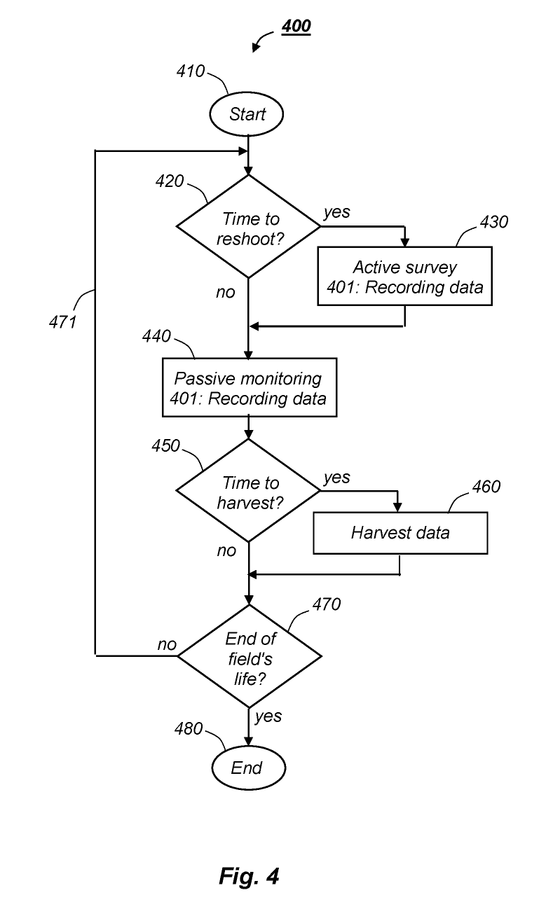

FIG. 4 illustrates a method 400 for operating the system 100.

Step 410 includes all steps required prior to operations, e.g. installing the vertical arrays 110 in shallow boreholes in the seabed 10 as described previously. While not shown explicitly in FIG. 4, is should be understood that vertical arrays 110 may be added to the system during operation. This allows the system 100 to grow, for example from a pilot system similar to the embodiment in FIG. 2 to a full scale system as shown in FIG. 3.

Decision 420 determines when it is time to mobilise a source vessel and perform a monitoring survey, i.e. perform an active survey 430.

In step 430, airgun shots will be fired in an active survey to provide an active dataset for analysis and/or to calibrate the sensor array. During a survey 430, e.g. an instance in a 4D time lapse series, the vertical array(s) 110 continuously record the seismic wavefield in the subsurface. Such scheduled active surveys 430 confirm or adjust changes made to the ground model during a previous period of passive monitoring 440.

Step 440 illustrates that the system 100 performs passive monitoring between active surveys 430. The order of steps 430 and 440 is arbitrary in the sense that step 430 may be performed before passive monitoring 440 in a pilot installation, whereas a new vertical array 110 may be deployed anytime between active surveys 430 and hence start with step 440.

Steps 430 and 440 both include a step 401: Recording data. Hence, most or all seismic receivers 120 should have a dynamic range allowing for tiny passive seismic signals from natural and man-made microseismic events nearby in step 440 as well as more powerful reflections from an active source during active seismic acquisition in step 430. Recording 401 starts as soon as the node 140 is connected to the sensor array 110 and will continue until the battery runs out or the recording node 140 is replaced.

Decision 450 implements a schedule for when to send data to the surface.

Step 460 includes transmitting recorded data to the underwater vessel 300, e.g. over a high-speed optical link every few weeks or months. Step 460 also includes disconnecting the entire recording node 140 from the connector 130 at regular intervals, e.g. every 1-2 years, for uploading data to a central digital storage, maintenance, calibration and recharging or replacing batteries.

Decision 470 illustrates that the system 100 is designed to operate until the end of life for the field, e.g. as opposed to a 4D OBS array with recording nodes deployed on the seafloor for the duration of an active survey.

Step 480 includes any required cleanup and decommissioning work, e.g. removing a recording node 140 while leaving the vertical array(s) 110 in the seabed 10.

While the invention has been described by examples with reference to specific embodiments, the scope of the invention is defined by the following claims.

1-13. (canceled)

14. An offshore reservoir monitoring system comprising:
a vertical array with multiple seismic receivers configured for installation in a seabed; and
a recording node for recording data from the multiple seismic receivers, wherein the spacing between adjacent seismic receivers is less than 10 m.

15. The system according to claim 14, wherein several vertical arrays are deployed in dedicated boreholes in the seabed.

16. The system according to claim 15, wherein the distance between vertical arrays is larger than the spacing between adjacent seismic receiver levels.

17. The system according to claim 14, wherein a seismic receiver comprises three orthogonal geophones.

18. The system according to claim 14, wherein a seismic receiver comprises a hydrophone.

19. The system according to claim 14, wherein the vertical array is a fully sealed system with fibre-optic seismic sensors.

20. A method for operating a system according to claim 14, comprising the steps of:
installing the system;
recording data from the seismic sensors on the recording node;
performing an active survey at first predetermined intervals;
monitoring microseismic events between active surveys; and
harvesting data from the recording node at second predetermined intervals using an underwater vessel.

21. The method according to claim 20, wherein installing the system includes providing the borehole by a technique selected from a group consisting of flush drilling, percussion drilling and drilling with a drill bit.

22. The method according to claim 20, wherein recording data includes signal processing in the recording node.

23. The method according to claim 20, wherein recording data includes deriving a vector gradient of a wave field.

24. The method according to claim 20, wherein harvesting data includes retrieving the recording node from the seabed.

25. The method according to any claim 20, further comprising the step of sampling data for suppressing coherent noise.

26. The method according to any claim 20, further comprising the step of sampling data for separating up-going and down-going wave fields.
